(19) United States
(12) Patent Application Publication
(10) Pub. No.: US 2003/0039030 A1
(43) Pub. Date: Feb. 27, 2003

(54) Reflective sheets and applications therefor

(76) Inventor: Kenneth J. Myers, Dobbs Ferry, NY (US)

Correspondence Address: BACON & THOMAS, PLLC, 625 SLATERS LANE, FOURTH FLOOR, ALEXANDRIA, VA, 22314

(21) Appl. No.: 09/934,641

(22) Filed: Aug. 23, 2001

(51) Int. Cl. G03B 21/56; G03B 21/60

(52) U.S. Cl. 359/449; 359/455

(57) ABSTRACT

Reflectors suitable for use in rear projection television systems, LCD projectors and stereoscopic effects devices, and numerous other applications, include a substrate having a microprism or lenticulated sheet structure, and in which one or more surfaces are made reflective through the use of polishing or the addition of a reflective coating. The reflective surface or surfaces may include a planar rear surface of the substrate, in which case the remaining intersecting front surfaces of the sheet are arranged to expand, shift, or reduce an image incident on the front surface of the sheet as the rays of the image pass through the sheet and are reflected by the reflective surface. Alternatively, the reflective surface or surfaces may be intersecting front surfaces and/or curved surfaces of the sheet and the generally planar rear surface of the sheet may be treated or shaped to expand, shift, reduce, or otherwise modify the image reflected by the angled or curved reflective surfaces. In the case where the angled surfaces include pairs of intersecting surfaces, at least one of the surfaces in each pair may be left transparent so as to transmit light and thereby provide a beam splitting effect.

### BACKGROUND OF THE INVENTION

1. Field of the Invention

This invention relates to reflective sheets having image expanding, reducing, and/or shifting properties, and to applications utilizing such sheets. The applications include rear projection television systems, in which the reflective sheets are used to expand the projected image without increasing the path length, thereby reducing the overall size of the systems. Other applications include use of the reflective sheets as beam splitters of image combiners in LCD projectors and in stereoscopic devices of the type disclosed in copending U.S. patent application Ser. Nos. 09/481,942, filed Jan. 30, 2000, 09/538,731, filed Mar. 30, 2000, and 09/729,079, filed Dec. 5, 2000, herein incorporated by reference.

The reflective sheets are made up of transparent microprism or lenticular substrates, one or more surfaces of which are provided with a reflective coating, or a reflection-causing surface treatment such as polishing. The remaining surfaces may be formed into lens shapes or otherwise coated or treated to provide such optical effects as image expansion, reduction, or shifting, as well as light diffusion, polarization, and so forth, to provide a wide variety of optical effects in a relatively simple and easy-to-manufacture.

2. Description of Related Art

In projection television systems, mirrors are used to create a relatively long path length between the projector and the projection screen, so that the relatively small image from a projector is enlarged to cover the screen. The effect is the same as if the projector were moved away from the screen and the images were projected straight onto the front of the screen. The farther back the projector, the larger the image. Similarly, the longer the path length resulting from multiple reflections, the larger the image.

The need for a relatively long optical path between the projector and the screen limits the extent to which the size of the projector can be reduced. While lenses may be used to enlarge the image as it traverses the optical path to the screen, lenses are expensive and may cause distortion of the viewed image.

One way to shorten the optical path is to project the image onto the back of the screen at a relatively acute angle relative to the plane of the screen. Lenticular elements that are normally included in the screen to collimate the image and reduce glare may be modified to compensate for the angle at which the image intersects the screen. A basic rear projection screen arrangement is illustrated in U.S. Pat. No. 4,147,408, while modifications of the projection system for the purpose of reducing the size of the system without reducing the optical path length, and therefore the size of the projected image, are disclosed in U.S. Pat. Nos. 4,512,631; 4,578,710; 4,708,435; 4,963,016; 5,208,620; and 5,803,567.

No matter how the relationship between projector, mirror, and screen is adjusted, however, a limitation on size reduction is provided by the mirror itself. In general, the closer the mirror is to the screen, the larger the mirror required, offsetting any gains from repositioning of the mirror. For conventional mirrors, the laws of physics essentially dictate a minimum mirror size and maximum angle between the mirror and the screen.

The present invention solves the mirror-size and positioning problem by utilizing a mirror that incorporates lenticular elements to expand the image and reduce the size of the mirror, permitting the mirror to be placed closer to the screen and at a smaller angle relative to the plane of the screen, while eliminating the need for additional lenses or other optical elements designed to provide the same effect.

In addition, the principles of the invention may be extended to encompass a wide variety of reflector configurations, including reflectors having image reduction or shifting effects, privacy screening mirrors, and “half-silvered” or beam splitting mirrors. Consequently, the reflectors of the invention can be used in any of a variety of applications where a reduced mirror size would be beneficial, and even in applications where conventional mirrors would be adequate, but in which the reflectors of the invention have an advantage in terms of cost, weight, or simplicity. Two such applications are to combine images (or provide enhanced backlighting) in an LCD projector, and to combine left and right eye images in a stereoscopic projection device.

Although the reflectors of the invention of the first three embodiments of the present invention (relating to non-beam splitting reflectors) are believed to be completely unique, beam-splitting reflectively-coated prism arrangements similar to those of the fourth preferred embodiment of the invention are disclosed in U.S. Pat. No. 5,317,405. According to this patent, as illustrated in FIGS. 1A and 1B herein, one of the parallel intersecting surfaces 5 of what appears to be a microprism sheet 2 is reflectively coated while the other of the intersecting surfaces 6 is left transparent to form a reflector that is intended to be placed in front of a display 1 so as to reflect the image of a viewer to a camera 4 (and, in the case of an LCD, a polarizer 3) while permitting the viewer to view the display, and thereby participate in a video conferencing call.

Despite the shared reflection/transmission function, any resemblance between the reflectors included in the video conferencing system of U.S. Pat. No. 5,317,631 and those of the fourth preferred embodiment of the present invention is essentially coincidental and U.S. Pat. No. 5,317,631 does not suggest any of the reflector modifications or applications disclosed herein.

In particular, the video conferencing system disclosed in U.S. Pat. No. 5,317,631 does not include any sort of image modifying or shifting elements, and would not benefit from such elements. The patent certainly does not suggest any of the non-beam splitting embodiments of the present invention since beam splitting is essential to the video conferencing concept, nor could the patent possibly have suggested image expanding, shifting, or reduction since the reflected image path is to an external camera, and therefore positioning of the camera, or the person whose image is being captured, is not limited by a need to make the device more compact. In addition, U.S. Pat. No. 5,317,405 does not suggest application to rear projection television systems, or for use as beam splitter/image combiners in LCD projectors or stereoscopic projection devices.

While the shapes of the lenticular elements or optical surfaces of the reflectors of the present invention, and the principles of optics underlying those shapes, are also similar to corresponding shapes and principles exhibited by the light transmitting sheets disclosed in copending U.S. patent application Ser. No. 09/846,455, filed May 2, 2001, the fact that those shapes and principles can be applied to reflectors of the type disclosed herein, thereby obtaining a new type of reflector having exceptional versatility, is clearly not expected from the related art discussed above.

### SUMMARY OF THE INVENTION

It is accordingly a first objective of the invention to provide reflectors having greater versatility than conventional reflectors without a corresponding increase in complexity.

It is a second objective of the invention to provide a substantially planar reflector structure that permits the reflector to easily be arranged to exhibit image expanding, shifting, or reducing effects in a reduced space relative to curved conventional mirrors providing the same effects.

It is a third objective of the invention to provide a reflector suitable for use in a rear projection television system, and yet that permits a significant reduction in the size, and in particular the depth, of the system.

It is a fourth objective of the invention to provide a rear projection television system having a “flatter” screen than is possible with conventional rear projection systems.

It is a fifth objective of the invention to provide a relatively simple image-combining reflector suitable for use in an LCD image projector, and an LCD image projector utilizing same.

It is a sixth objective of the invention to provide a relatively simple image-combining reflector suitable for use in a stereoscopic imaging device, and to provide a stereoscopic imaging device utilizing same.

These objectives are accomplished, in accordance with the principles of a preferred embodiment of the invention, by providing reflectors consisting of a substrate having a microprism or lenticulated sheet structure, which may be made either of transparent plastic or glass, and in which one or more planar and/or curved surfaces are made reflective through the use of polishing or the addition of a reflective coating.

In a first preferred embodiment of the invention, the reflective surface is a planar rear surface of the substrate, and the remaining intersecting front surfaces of the sheet are arranged to expand, shift, or reduce an image incident on the front surface of the sheet as the rays of the image pass through the sheet and are reflected by the reflective surface.

In a second preferred embodiment of the invention, angled front surfaces and/or curved surfaces of the sheet are made reflective and the generally planar rear surface of the sheet is treated or shaped to exhibit image modifying properties, while in a third preferred embodiment of the invention, the reflective surface is formed on lenticular or curved portions of the sheet, while the opposite surfaces are further modified to expand, shift, reduce, or otherwise modify the image reflected by the curved reflective surfaces.

Finally, in a fourth preferred embodiment of the invention, only one of the intersecting surfaces is made reflective, thereby forming a beam splitter or image combiner, the remaining surfaces being shaped to modify either or both of the transmitted and reflected images.

In each of the embodiments of the invention, the non-reflective portions of the reflector may be selectively modified to exhibit diffusion effects in order to provide at least a partial screening effect, may be formed with additional lenticular structures in any orientation, and/or may be otherwise modified to provide such effects as polarization, glare reduction, radiation screening, and so forth.

### BRIEF DESCRIPTION OF THE DRAWINGS

FIG. 1A is a schematic diagram of the video conferencing system disclosed in U.S. Pat. No. 5,317,405.

FIG. 1B is a side view of the beam-splitting reflector used in the video conferencing system of U.S. Pat. No. 5,317,405.

FIGS. 2A, 3A, and 4A are side views of reflectors arranged according to the principles of a first preferred embodiment of the present invention.

FIGS. 2B, 3B, and 4B are isometric views of the reflectors of the first preferred embodiment.

FIGS. 2C, 3C, and 4C are enlarged side views of individual elements of the reflectors of the first preferred embodiment.

FIGS. 5A-5C are isometric views of a variation of the reflector of the first preferred embodiment.

FIG. 6 is a side view of another reflector constructed in accordance with the principles of the first preferred embodiment.

FIGS. 7A and 8A are side views of reflectors constructed in accordance with the principles of a second preferred embodiment of the invention.

FIGS. 7B and 8B, 9B, 10B, 11B, 12B, and 13B are enlarged side views of individual elements of the reflectors of the second preferred embodiment.

FIGS. 9A, 10A, and 11A are side views of reflectors constructed in accordance with the principles of a third preferred embodiment of the invention.

FIGS. 9B, 10B, and 11B, 12B, and 13B are enlarged side views of individual elements of the reflectors of the third preferred embodiment.

FIG. 12 is a side view of a reflector that combines aspects of the second and third preferred embodiments of the invention.

FIG. 13 is a side view of a variation of the reflectors of the second preferred embodiment.

FIGS. 14A, 15A, 16A, 17A, 18A, 19A, and 20A are side views of reflectors constructed in accordance with the principles of a fourth preferred embodiment of the invention.

FIGS. 14B, 15B, 16B, 17B, 18B, 19B, and 20B are enlarged side views of individual elements of the reflectors of the fourth preferred embodiment.

FIG. 21 is a schematic diagram of a rear projection television system constructed in accordance with the principles of a fifth preferred embodiment of the invention.

FIGS. 21A-21C are side views of various mirror configurations that could be used in the rear projection television system of FIG. 21, with FIG. 21C showing an especially preferred mirror configuration.

FIG. 22 is a schematic diagram of an LCD projector constructed in accordance with the principles of a sixth preferred embodiment of the invention.

FIG. 23 is a schematic diagram of a stereoscopic imaging device constructed in accordance with the principles of a seventh preferred embodiment of the invention.

### DETAILED DESCRIPTION OF THE PREFERRED EMBODIMENTS

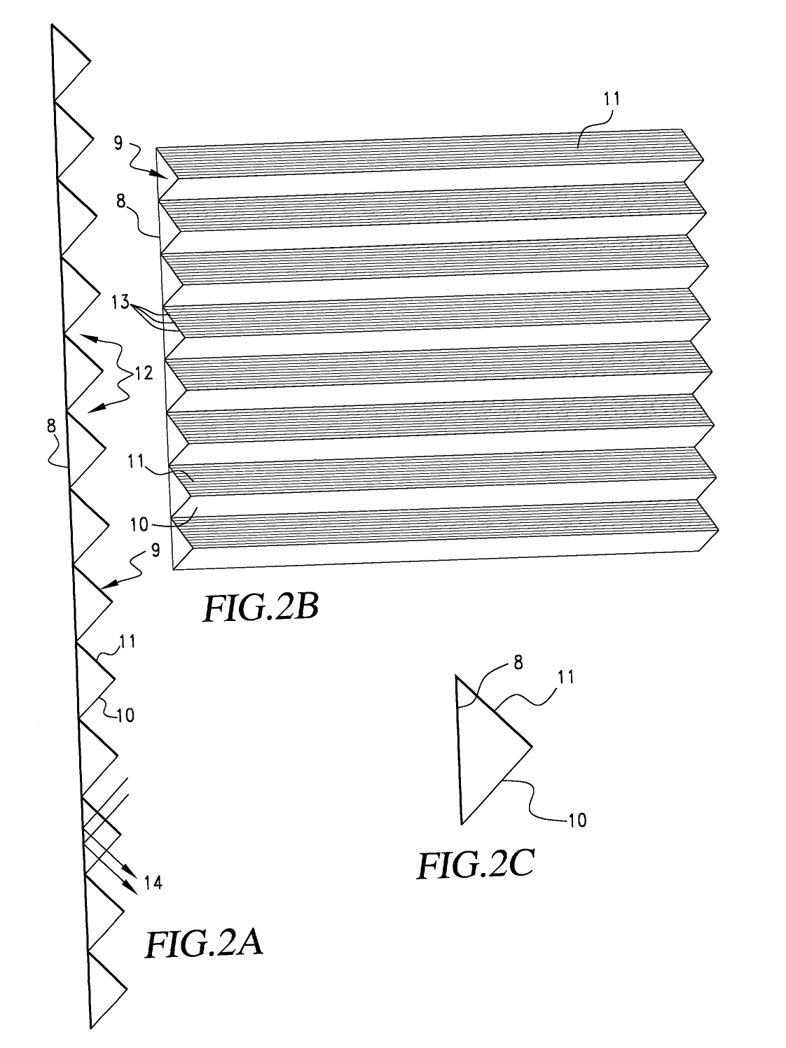

FIGS. 2A-5A, 2B-5B, and 2C-5C illustrate various reflectors constructed in accordance with the principles of a first preferred embodiment of the invention. The reflectors of the first preferred embodiment share a substrate made of a transparent material such as glass or plastic formed on a first side with a plurality of “one dimensional” parallel prismatic and/or lenticular structures (referred-to for convenience as the “front” side) and with a planar surface on the rear side, the planar surface serving as the reflective surface.

As in all of the embodiments of the present invention, the reflective surface of the first preferred embodiment of the invention may be formed by any reflector-creating method or apparatus known, or that may become known, to those skilled in the art, including coating or deposition methods that place a reflective material such as a metal on the substrate, lamination methods, and methods of creating reflectors by polishing of the appropriate surfaces. The front surfaces of the various reflectors shown in FIGS. 2A-5A, 2B-5B, and 2C-5C are configured to enlarge, reduce, or shift images incident on the front surface of the substrate and reflected by planar reflective surface 8 back through the front surface.

In particular, in the version of the first preferred embodiment illustrated in FIGS. 2A-2C, the non-reflective prism structures are formed by two intersecting planar surfaces 10 and 11 that form parallel grooves 12. Surface 10 is transparent while surface 11 may be formed with a plurality of micro lenticular structures 13 extending parallel to the grooves 12 formed by the surfaces of the prism structures.

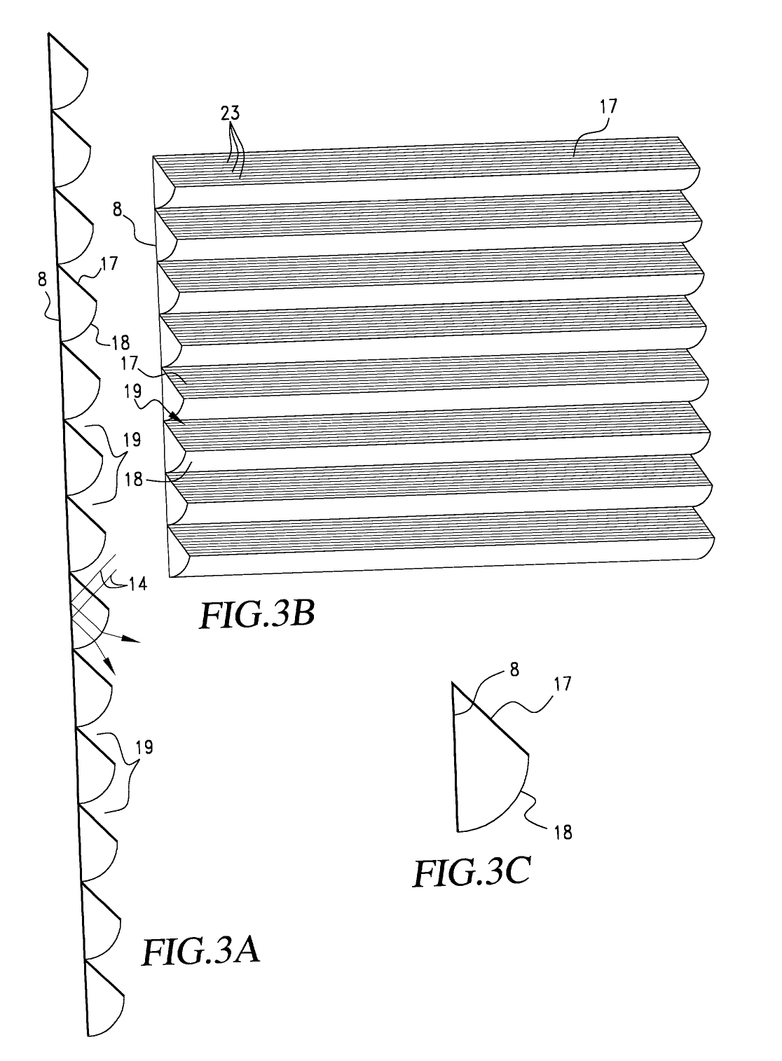

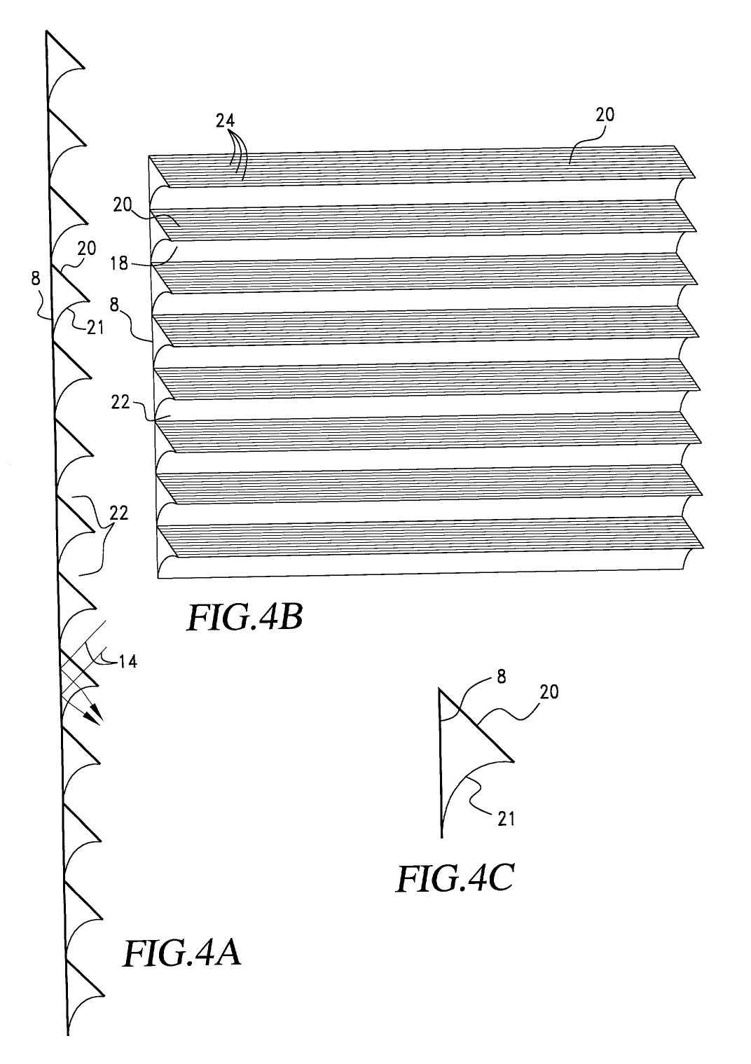

On the other hand, in the version of the first preferred embodiment illustrated in FIGS. 3A-3C, the prism structures are formed by planar surfaces 17 and convex surfaces 18 that intersect to form parallel grooves 19, while in the version illustrated in FIGS. 4A-4C, the prism structures are formed by planar surfaces 20 and concave surfaces 21 that intersect to form parallel grooves 22. Planar surfaces 17 and 20 again include lenticular structures 23 and 24 extending parallel to the grooves 19, with the respective convex surfaces 18 and concave surfaces 21 serving to further shift the image to project onto the screen.

It will of course be appreciated by those skilled in the art that the effect of convex or concave surfaces on the image will depend on the angle of incidence, i.e., on the orientation of the reflector relative to the immediate source of the image incident on the reflector, and also on whether light rays 14 illustrated in FIGS. 2A, 3A, and 4A initially encounter the planar surface or the curved surface, if any, of the respective reflector. For example, as illustrated, the reflector of FIG. 3A serves to enlarge a reflected image, and thus is especially suitable for use in a rear projection television system. However, if the reflector is turned upside-down relative to the image source, image compression will result. Similar, the reflector of FIG. 4A reduces the size of an image when in the illustrated vertical orientation, but enlarges the image when in reverse vertical orientation.

FIGS. 5A-5C show respective variations of the planar reflector structures of FIGS. 2A-2C, 3A-3C, and 4A-4C, in which the lenticular structures 25-27 of surfaces 11, 17, and 20 are oriented 90° relative to the corresponding lenticular structures 13, 23, and 24 of FIGS. 2A-2C, 3A-3C, and 4A-4C. Alternatively, as in all of the preferred embodiments of the present invention, any of the non-reflective surfaces, including surfaces 11, 17, and 20, and possibly surfaces 10, 18, and 21, may be altered in ways other than lenticulation, for example by applying a diffusing coating or by roughening the appropriate surfaces to diffuse or scatter light to provide a screening effect, as well as by providing a polarizing coating, by adding printing to create visible patterns or messages, and so forth.

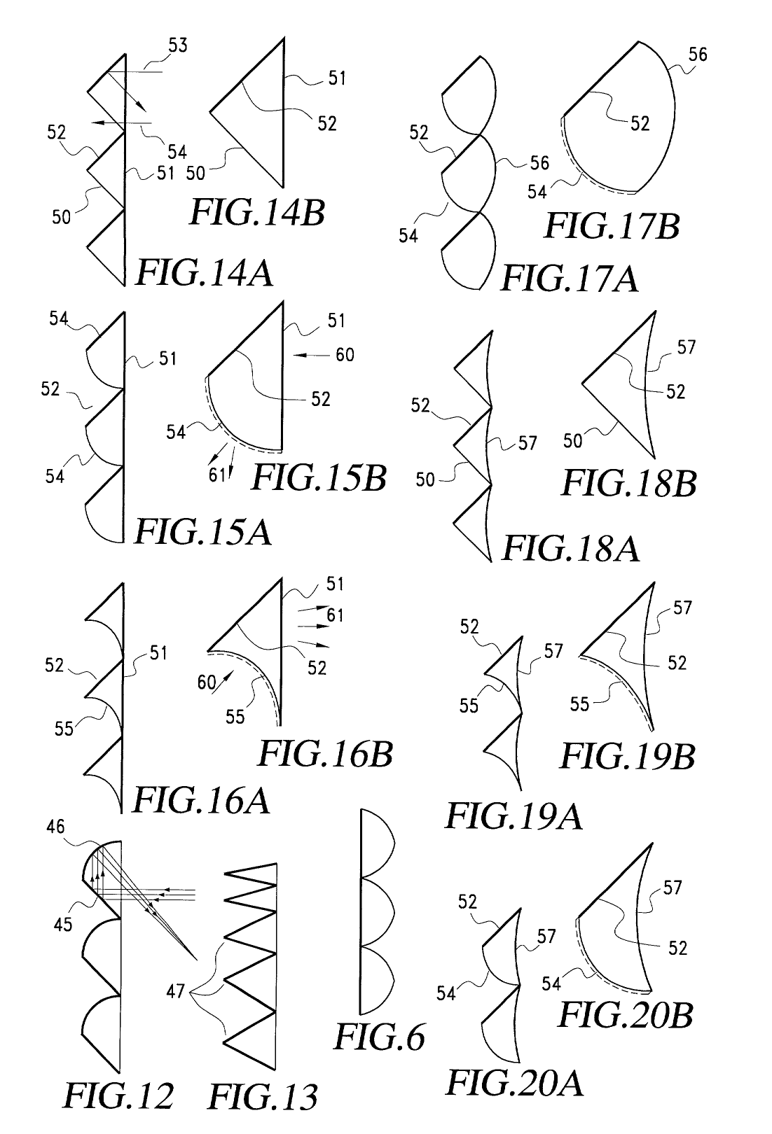

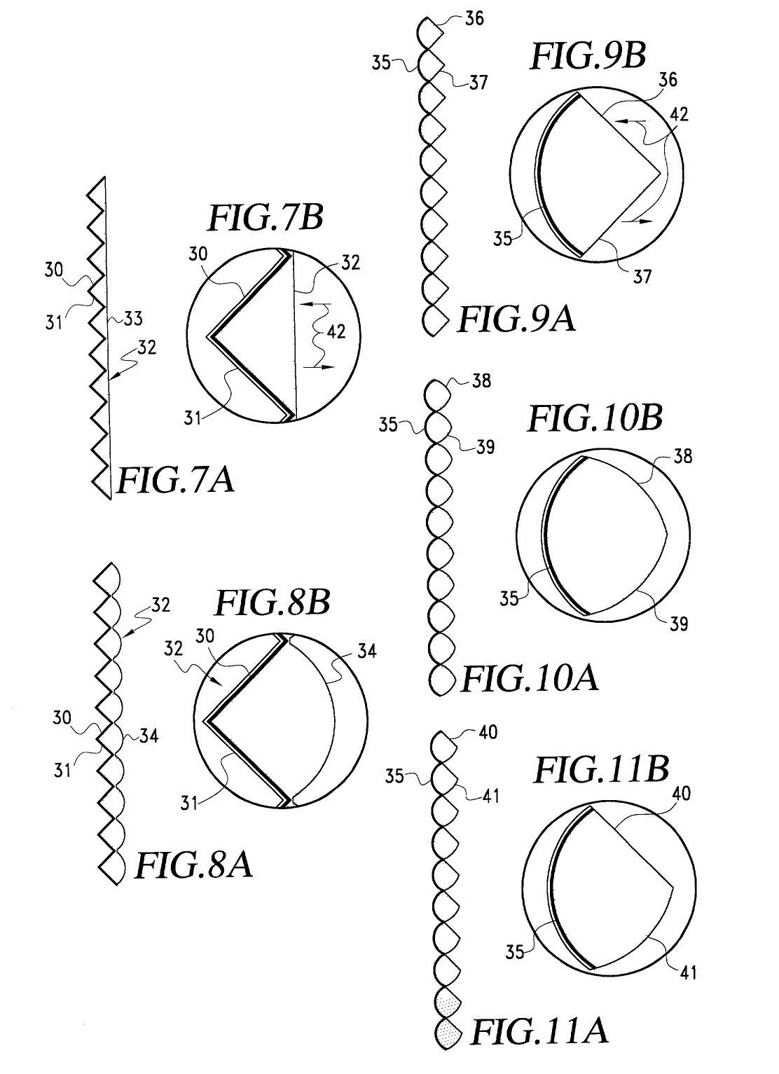

The second preferred embodiment differs from the first preferred embodiment in that the reflective surfaces are the angled surfaces opposite the planar rear surface corresponding to surface 8 of the first preferred embodiment. In particular, in the second preferred embodiment shown in FIGS. 6A, 6B, 7A, and 7B, planar reflective surface 8 is replaced by reflecting surfaces 30 and 31, which may be coated, laminated, or otherwise formed on substrate 32, to thereby provide a retroreflective effect that directs light back at the source.

As in the first preferred embodiment of the invention, the retroreflective effect may be enhanced by replacing the planar surface 33 of the reflector illustrated in FIGS. 6A and 6B with a concave surface 34, as illustrated in FIGS. 7A and 7B, or with any other image enhancing configuration. It will of course be appreciated that micro-lenticular structures, as well as other coatings or surfaces treatments, may be applied to any of the non-reflective surfaces of the reflectors of this embodiment in a manner similar to that discussed above with respect to the first preferred embodiment of the invention.

According to the principles of a third preferred embodiment of the invention, illustrated in FIGS. 9A-11A and 9B-11B, the reflective surface 35 is a curved surface having an arc-shaped cross-section and arranged in rows to form “one-dimensional” cylindrical or barrel lens structures. As in the other embodiments of the invention, the remaining pairs of non-reflective surfaces 36, 37, 38, 39, and 40, 41 may be configured to achieve a desired optical effect, whether symmetrically as in FIGS. 9A, 9B and 10A, 10B, or asymmetrically as in FIGS. 11A, 11B. The direction of incident and reflected light for the illustrated variations of the second and third embodiments is generally indicated in FIGS. 7A and 9A by arrows 42.

FIG. 12 shows a reflector arrangement which combines a planar reflector 45, as in the second preferred embodiment of the invention, with a curved or arc-shaped reflector 46, as in the third preferred embodiment. The optical effect of this arrangement is indicated by light rays 47. This version of the second and third embodiments is intended to illustrate that the invention is not to be limited to a particular reflector or non-reflective surface shape, but rather that the shapes of the various surfaces are can be combined and varied in numerous ways without departing from the scope of the invention.

Similarly, as illustrated in FIG. 13, the shapes of the prism or lenticular structure need not be uniform across the reflector. In this arrangement, planar surfaces intersect at decreasing angles to form prisms 47, which may constitute either the reflective or non-reflective surfaces, although the principle of varying the shapes of the prisms or lenticular structures may of course be extended to curved lenticular structures.

The fourth preferred embodiment of the invention differs from the first three embodiments in that the reflective surface does not extend over an entire side of the substrate. Instead, only selected surfaces are made reflective, with gaps between the reflectors to form reflectors having the effect of a beam-splitter or half-silvered conventional mirror.

As illustrated in FIGS. 14A and 14B, the reflector of this embodiment of the invention includes light transmitting surfaces 50 and 51, and reflective surface 52 which together form a beam splitter as indicated by rays 53 and 54. Ray 53 is reflected by reflective surface 52, while ray 54 is transmitted through surfaces 50 and 51.

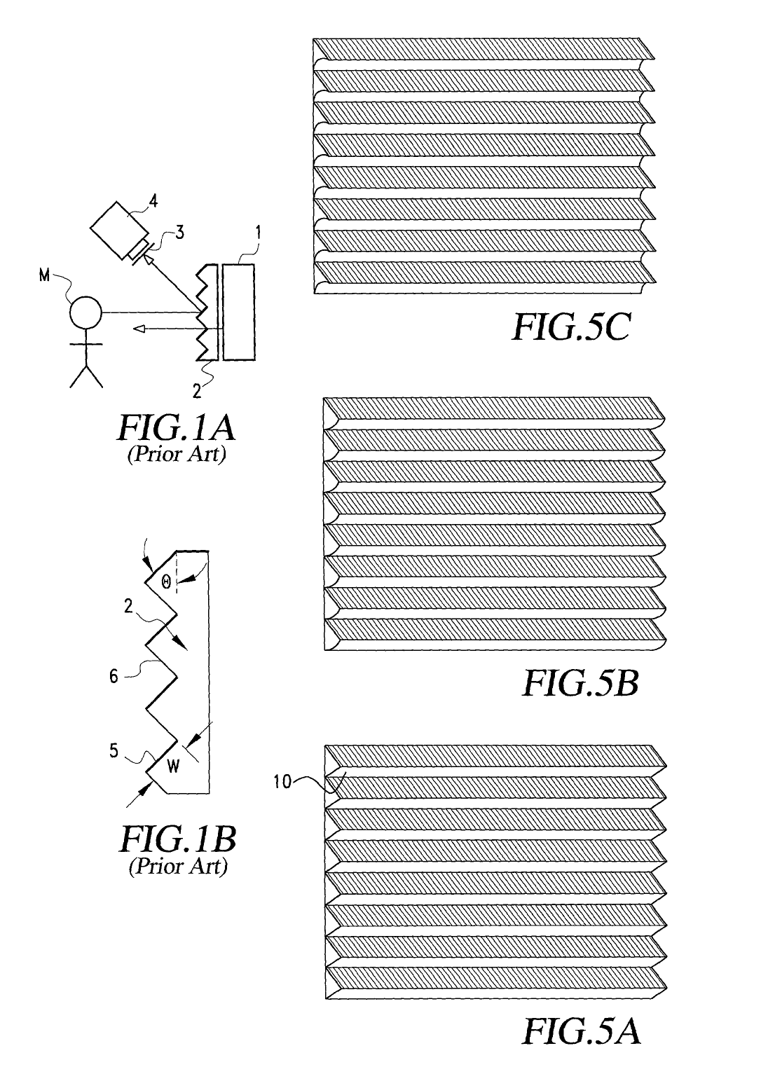

Those skilled in the art will note that the reflector of FIGS. 14A and 14B is structurally similar to the reflector of prior art FIG. 1, except that the reflector is arranged to internally reflect light incident from the planar side 51, rather than from the angled side of the substrate. This is a critical difference since, unlike the reflector of FIG. 1, the reflector of the present invention may be varied to expand, reduce, shift, or otherwise alter images reflected by the reflector.

In the example illustrated in FIGS. 15A, 15B and 16A, 16B, either the angled planar surface 52 or convex/concave surfaces 54, 55 may be made reflective (as suggested by the dashed lines), with the remaining non-reflective surfaces left transparent as in the variation shown in FIGS. 14A and 14B. The concave/convex surfaces can then be used to expand an image, depending on which side serves as the initial angle of incidence. For example, if surfaces 52 in FIGS. 15A, 15B are reflective, then concave surface 54 will serve to expand an image represented by incident rays 60 and reflected rays 61 that is initially incident on surface 51. On the other hand, if surfaces 52 in FIGS. 16A, 16B are reflective, then concave surface 55 will serve to expand an image represented by incident rays 60 and reflected rays 61 that is initially incident on concave surface 55.

Alternatively, as shown in FIGS. 17A, 17B, 18A, 18B, 19A, 19B, 20A, and 20B, the planar surface 51 may be replaced by respective convex or concave surfaces 56 and 57, with either or both of the remaining surfaces having a concave, convex, or planar shape, and one of the remaining surfaces being reflective. Again, the convex/concave surfaces may be used to expand an image depending on the side on which the image is initial incident, with dual curved surfaces either enhancing or modifying the desired optical effect. In addition, the variations illustrated in FIGS. 18A, 18B, 19A, 19B, and 20A, 20B in which front surface 57 is concave in shape can be arranged to provide a Fresnel or light collimating effect for reflected light incident on one of the opposite rear surfaces, permitting light to be directed straight out of the reflective sheet rather than at an angle. Finally, although not shown, it is also within the scope of the invention to space the lenticular or prism elements, particularly in the variations in which the front surface is made up of concave elements.

In summary, according to the principles of the fourth preferred embodiment of the invention, as suggested by FIGS. 14A-20A and 14B-20B, any of the three surfaces of each prism or lenticular element may be curved, and either of the two rear surfaces of the sheet, whether planar or curved, may be made reflective, with the other rear surface and the front surface arranged to transmit light.

The fifth preferred embodiment of the invention is a rear projection television system that utilizes a reflector corresponding to those of any of the first through third embodiments of the invention.

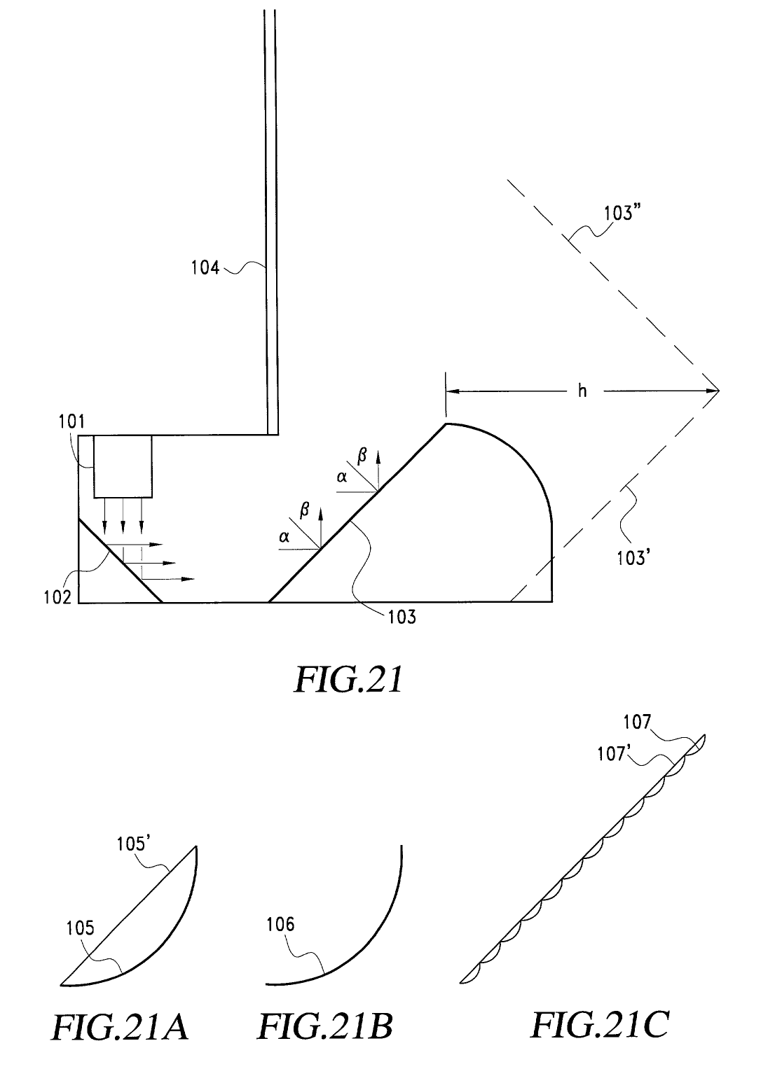

As illustrated in FIG. 21, the projection television system of FIG. 21 includes a projector 101, a first reflector 102 arranged to reflect the projected image rearwardly towards a second reflector, which in turn is arranged to reflect the image onto a projection screen 104. In a conventional rear projection television arrangement, two mirrors 103′ and 103″ would be provided to increase the path length traversed by the image to the screen, but according to the principles of the invention, mirrors 103′ and 103″ are replaced by a single reflector 103 arranged to project the image directly onto the screen at an oblique angle. Reflector 103 has the property that the angle of reflection β is less than the angle of incidence α, thereby enabling reflector 103 to be positioned closer to the screen by a distance h than is possible with reflectors 103′ and 103″. In addition, reflector 103 preferably provides an image expanding effect.

In order to obtain the requisite reflection angle, it is possible to use curved reflectors such as reflectors 105 and 106 respectively shown in FIG. 21A and 21B, including reflectors in which the curved surface is filled-in with a transparent material 105′. However, a preferred solution is to reflectively treat, coat, or laminate surface 107 of a substrate 107′ corresponding to the reflectors of the second preferred embodiment of the present invention, as illustrated in FIG. 21C, or to use any of the versions of the first, second, or third embodiments of the invention having the requisite image directing, shifting, or expanding properties.

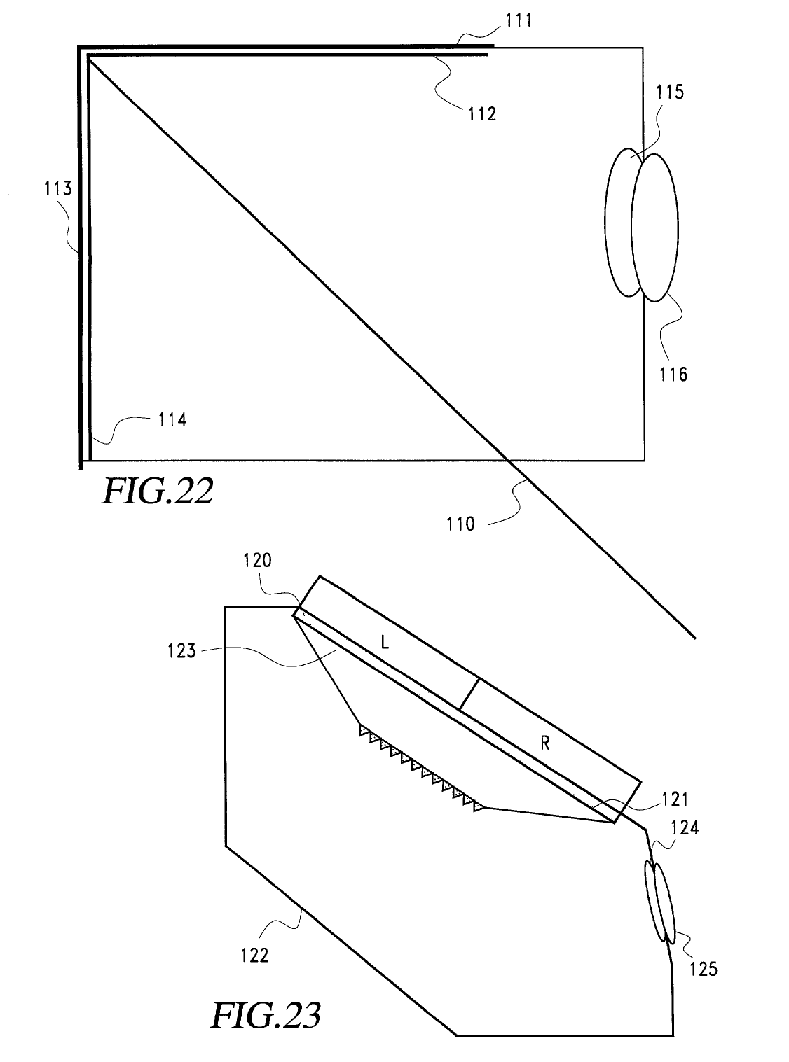

In the embodiment of FIG. 22, a reflector 110 arranged according to the principles of the fourth preferred embodiment of the invention is used to combine images from an LCD 111, polarizer 112, LCD 113, and polarizer 114. The reflector 110 directs images whose polarization has been shifted by polarizers 112 and/or 114 to polarizing lenses 115 and 116 by reflecting the image from LCD 111 and transmitting the image from LCD 113 (in some arrangements, one of the polarizers may be omitted since light from an LCD is already polarized). LCD 113 may be a semi-transparent LCD arranged to provide back-lighting for the image from LCD 111.

Finally, in the embodiment of FIG. 23, LCD 111 is replaced by side-by-side left and right eye image sources 120 and 121 of a stereoscopic projection system arranged according to the principles described in copending U.S. patent application Ser. Nos. 09/481,942, filed Jan. 30, 2000, 09/538,731, filed Mar. 30, 2000, and 09/729,079, filed Dec. 5, 2000, to include beam splitter 122 corresponding to the beam splitters of the fourth preferred embodiment of the present invention, polarizers 123 and/or 124, microprism image interlacing sheet 125, and polarizing lenses 126 and 127.

Having thus described a preferred embodiment of the invention in sufficient detail to enable those skilled in Fly the art to make and use the invention, it will nevertheless be appreciated that numerous variations and modifications of the illustrated embodiment may be made without departing from the spirit of the invention, and it is intended that the invention not be limited by the above description or accompanying drawings, but that it be defined solely in accordance with the appended claims.

I claim:

1. A reflective sheet, comprising:
a single transparent substrate having first and second surfaces,
wherein at least one of said first and second surfaces has a microprism or lenticular structure, and
wherein at least a portion of one of said first and second surfaces is arranged to reflect light transmitted through the substrate.

2. A reflective sheet as claimed in claim 1, wherein said at least one of said first and second surfaces that has a microprism or lenticular structure is said first surface, and wherein said one of said first and second surfaces that is arranged to reflect light transmitted through the substrate is said second surface, whereby an image reflected by said second surface is enlarged, shifted, or reduced by said microprism or lenticular structure of said first surface.

3. A reflective sheet as claimed in claim 2, wherein said second surface is planar.

4. A reflective sheet as claimed in claim 2, wherein said first surface includes intersecting planar surfaces, a first of which includes microlenticular elements.

5. A reflective sheet as claimed in claim 4, wherein a second of said intersecting planar surfaces is a light diffusing surface.

6. A reflective sheet as claimed in claim 1, wherein said at least one of said first and second surfaces that has a microprism or lenticular structure is said first surface, and wherein said one of said first and second surfaces that is arranged to reflect light transmitted through the substrate is also said first surface, whereby an image transmitted through said second surface is enlarged, shifted, or reduced by said microprism or lenticular structure as it is reflected by said first surface.

7. A reflective sheet as claimed in claim 6, wherein said microprism or lenticular structure includes first planar surfaces and second planar surfaces that intersect to form microprisms, and wherein both said first planar surfaces and said second planar surfaces are arranged to reflect light.

8. A reflective sheet as claimed in claim 6, wherein said microprism or lenticular structure includes first planar surfaces and second planar surfaces that intersect to form microprisms, and wherein only said second planar surfaces are arranged to reflect light, said first planar surfaces being arranged to transmit light, thereby forming a beamsplitter.

9. A reflective sheet as claimed in claim 6, wherein said microprism or lenticular structure includes arc-shaped elements.

10. A reflective sheet as claimed in claim 1, wherein said portion of said reflective surfaces is coated with a reflective material.

11. A reflective sheet as claimed in claim 1, wherein said portion of said reflective surfaces is polished to increase a reflectivity of said portion.

12. A rear projection television system, comprising:
an image source; a screen; and at least one reflector arranged to project and image from said image source onto said screen, and wherein said reflector comprises a single transparent substrate having first and second surfaces, at least one of said first and second surfaces having a microprism or lenticular structure, and at least a portion of one of said first and second surfaces being arranged to reflect light transmitted through the substrate.

13. A reflective sheet as claimed in claim 12, wherein said at least one of said first and second surfaces that has a microprism or lenticular structure is said first surface, and wherein said one of said first and second surfaces that is arranged to reflect light transmitted through the substrate is said second surface, whereby an image reflected by said second surface is enlarged or shifted by said microprism or lenticular structure of said first surface.

14. A reflective sheet as claimed in claim 12, wherein said at least one of said first and second surfaces that has a microprism or lenticular structure is said first surface, and wherein said one of said first and second surfaces that is arranged to reflect light transmitted through the substrate is also said first surface, whereby an image transmitted through said second surface is enlarged or shifted by said microprism or lenticular structure as it is reflected by said first surface.

15. A reflective sheet as claimed in claim 14, wherein said microprism or lenticular structure includes arc-shaped elements.

16. A reflective sheet as claimed in claim 12, wherein said portion of said reflective surfaces is coated with a reflective material.

17. A reflective sheet as claimed in claim 12, wherein said portion of said reflective surfaces is polished to increase a reflectivity of said portion.

18. An LCD projector, comprising;
first and second LCDs;
a beam splitter arranged to reflect light from at least one of said first and second LCDs to a projection lens, said beam splitter being first arranged to transmit light to be combined with light from said one of said first and second LCDs,
wherein said beam splitter comprises a single transparent substrate having first and second surfaces, said first surface having a microprism or lenticular structure, a first portion of said first surface being arranged to reflect light transmitted through the substrate, and a second portion of said first surface being arranged to transmit light.

19. A reflective sheet as claimed in claim 18, wherein said first portion of said first surface is coated with a reflective material.

20. A reflective sheet as claimed in claim 12, wherein said first portion of said first surface is polished to increase a reflectivity of said portion.
